(19) United States
(12) Patent Application Publication
(10) Pub. No.: US 2026/0298838 A1
(43) Pub. Date: Oct. 1, 2026

(54) Measuring of surface deformations on glass surfaces

(71) Applicant: Viprotron GmbH, Pfungstadt (DE)

(72) Inventors: Kai VOGEL, Seeheim-Jugenheim (DE); Andreas SANDNER, Weiterstadt (DE)

(73) Assignee: Viprotron GmbH, Pfungstadt (DE)

(21) Appl. No.: 19/477,565

(22) PCT Filed: Apr. 24, 2024
(86) PCT No.: PCT/EP2024/061228

§ 371 Date: Oct. 22, 2025

(30) Foreign Application Priority Data
Apr. 24, 2023 (LU) LU504045

(51) Int. Cl. G01N 21/896; G01B 11/25; G01B 11/30; G01M 11/08; G01N 21/84; G01N 21/88

(52) U.S. Cl. CPC G01N 21/896; G01B 11/2513; G01B 11/303; G01M 11/081; G01N 21/8806; G01N 2021/845; G01N 2021/8965

(57) ABSTRACT

A measuring method and a measuring device serve for determining the flatness of a transparent pane. By a transport device, the pane is moved relative to an illumination device and a camera, or the illumination device and the camera are moved relative to the pane in a transport direction. The illumination device projects a light pattern consisting of several two-dimensional light pattern features onto the pane next to each other in a transverse axis oriented perpendicular to the transport direction. The light pattern reflected by the pane is captured by the camera. A geometric parameter of the light pattern features recorded by the camera is determined. The change in the geometric parameter of one or more light pattern features caused by the reflections on the pane is evaluated on the basis of several images captured in succession by the camera. The camera is designed as a line scan camera.

### CROSS-REFERENCE TO RELATED APPLICATION

This application is a national stage application, filed under 35 U.S.C. § 371, of International Patent Application PCT/EP2024/061228, filed on Apr. 24, 2024, which claims the benefit of Luxembourg Patent Application LU 504045, filed on Apr. 24, 2023.

### TECHNICAL FIELD

The invention relates to a measuring method and a measuring device for determining the flatness of a transparent pane.

### BACKGROUND

Optical distortions can be caused by the reflection of light rays on surface deformations on the surface of the pane. These surface deformations are often caused by the tempering process during the refinement of the glass pane. When glass panes ar ly tempered or annealed, they are transported by a conveyor system through a heated oven, where they are heated to a critical temperature at which internal stresses are relieved.

Achieving the critical temperature evenly is challenging with glass panes, which are usually large, without softening the glass pane. Typically, the glass pane locally reaches a softening point at which the glass is in a deformable state. During the manufacturing process, the glass pane usually rests on a large number of heat-resistant ceramic rollers on the conveyor system and is transported through the furnace in this manner. The force of gravity acting on the glass pane causes the locally softened glass pane to deform. This results in warping or deformation of the glass sheet due to gravity-induced sagging of the glass sheet in the space between two transport rollers. At a high preheating temperature inside the furnace, the sag is more pronounced, which is reflected in the surface profile of the glass sheet and in its reflection properties. The sag on the glass pane along the transport direction is usually cyclical. The period between high points and low points is influenced, among other things, by the distance between adjacent transport rollers and by the concentricity of the transport rollers.

When the glass pane rolls on an out-of-round transport roller, the high points and low points are periodically imprinted into the glass pane. These high points and low points imprinted into a glass pane are clearly visible when using a glass pane, for example, under prestressing. The deformations caused by the sag between the rollers or by an out-of-round roller tend to be cyclical in nature and create a wave effect in the glass pane.

In addition to the high points and low points imprinted in the longitudinal direction in the glass pane, which are visible as a cyclic wave structure, a local distortion can also be seen in the glass pane along a transverse axis parallel to the longitudinal direction.

U.S. Pat. No. 7,345,698 B2 discloses a measuring method and a measuring device for detecting and measuring optical distortion in glass panes. In the measuring method, an optical magnification of a reflected circular light pattern feature is captured by a camera. For this purpose, a plurality of circular light pattern features are projected onto the glass and reflected as ellipses that map the local surface contours. Distortions in the glass surface are measured as local enlargement or reduction on the elliptical axis. The angle and size of the minor and major axes of the reflected ellipses provide data for mapping the surface profile of the glass. This method is not suitable for measuring several different surfaces of a glass pane, as the images of light pattern features reflected on several surfaces overlap, making it impossible to reliably distinguish which part of the reflection originates from which surface. In particular, the reflected image does not contain a single shape of each individual surface, but rather a composite image of the combined multiple reflections on the surfaces. This makes it impossible to perform an evaluation of the distortion separately for each of the respective reflecting surfaces.

The patent specification U.S. Pat. No. 10,161,879 B1 describes a further development of the device and method described above from the publication U.S. Pat. No. 7,345,698 B2. The method and device disclosed in patent specification U.S. Pat. No. 10,161,879 B1 are used to measure the surface profile and optical reflectance of one or more surfaces of transparent glass panes. A plurality of circular light pattern features are projected onto the glass surface, whereby the light pattern features are not projected onto the glass surface as filled shapes, but consist of an outline. This allows the distortion evaluation to be performed separately when the images reflected by the multiple glass surfaces overlap, so that the determined distortion of a light pattern feature can be assigned to the respective glass surface.

In the described and known measuring methods and measuring devices, the camera is positioned and oriented so that the light pattern features projected onto the pane are completely captured by the camera. This is the only way to evaluate the enlargement or reduction of the major or minor axes of the reflected ellipses. This requires the use of area cameras to capture the area of the pane in which the light pattern features are projected.

### SUMMARY

The disclosure relates to a measuring method and a measuring device for determining the flatness of a transparent pane, wherein the pane is moved relative to an illumination device and a camera, or the illumination device and the camera are moved relative to the pane in a transport direction by means of a transport device, wherein the illumination device projects a light pattern consisting of several two-dimensional light pattern features onto the pane, wherein the several light pattern features are projected onto the pane next to each other in a transverse axis oriented perpendicular to the transport direction, wherein the light pattern reflected by the pane is at least partially detected by the camera, wherein a geometric parameter of the light pattern features recorded by the camera is determined, and wherein an evaluation of a plurality of images captured sequentially by the camera reveals a change in the geometric parameter of one or more light pattern features caused by the reflections on the pane.

The task of the present disclosure is to provide a measuring method that enables simple and accurate measurement of the distortion of the glass pane during the manufacturing process of the glass pane.

This task is solved by forming a circumferential line of the light pattern features in each case by a polygonal line comprising several straight polygonal line sections, wherein polygonal line sections of adjacent light pattern features facing each other are not oriented parallel to each other. By projecting such light pattern features with known dimensions, the geometric parameter(s) can be easily determined. Since the feature distances between two adjacent light pattern features differ from each other at least in sections over their entire extent in the transport direction, the geometric parameters can be reliably determined from sections of the light pattern captured by the camera, so that the entire light pattern does not have to be captured or evaluated in the transport direction.

Since the transport device moves the pane relative to the illumination device and the camera, or the illumination device and the camera relative to the pane in the transport direction, the multiple images captured sequentially by the camera are recorded in different relative positions of the pane to the illumination device and the camera in order to determine the change in the geometric parameters. In this way, for example, a distortion of the light pattern feature in the transport direction can be determined.

Advantageously, light pattern features projected directly next to each other onto the pane are designed and arranged in such a way that all feature distances determined perpendicular to the transport direction between facing outer contours of the light pattern features projected directly next to each other differ from each other. Because the feature distances between two adjacent light pattern features differ from each other over their entire extent in the transport direction, the geometric parameters can also be reliably detected from sections of the light pattern captured by the camera, so that the entire light pattern does not have to be captured or evaluated in the transport direction. The light pattern can be formed, for example, from trapezoidal light pattern features. It is also possible and provided for that the light pattern is formed from parallelogram-shaped light pattern features, whereby an angle of inclination of light pattern features projected onto the pane immediately adjacent to each other differs from one another.

It is particularly advantageous that the light pattern is formed from triangular light pattern features. The projection of triangular light pattern features with known dimensions makes it particularly easy to determine a geometric parameter. For example, the length of a triangle side can be determined by a reference measurement and by evaluation of an image recorded by the camera. The image position of the reflected light pattern feature hitting an image sensor of the camera can also be evaluated.

Advantageously, it may be provided that the light pattern features are projected onto the pane in such a way that one side of each light pattern feature, such as a side of a triangle, lies completely within the recording region captured by the camera and is thus completely captured. When the pane moves relative to the camera and the illumination device in the transport direction, the geometric parameter, in this case the length of a side of the light pattern feature recorded by the camera, such as the triangle, is changed due to the surface deformation of the pane. By determining the changed length and with the known positioning of the camera and the illumination device relative to the pane, the magnitude of the surface deformation of the pane can be determined. The surface deformation can be in the form of a curvature of the pane or can be visible as a wave-like cyclic wave structure in the transport direction of the pane caused by the manufacturing process.

Advantageously, the light pattern features are formed from several trapezoidal light pattern feature parts arranged one behind the other in the transport direction and adjacent to each other.

By using trapezoidal light pattern features or trapezoidal light pattern feature parts, a minimum distance perpendicular to the transport direction between polygonal line sections facing each other in a e manner can be easily specified. By specifying a minimum distance, the individual polygonal line sections can be reliably differentiated from each other in the camera image. The minimum distance is advantageously adapted to a maximum thickness of the pane to be measured in order to be able to distinguish the polygon sections in the camera image, which are generated once by the reflection of the light pattern on the upper side of the pane and once on the lower side of the pane and are captured by the camera. By using several trapezoidal light pattern feature parts, the measuring range can be easily increased without impairing the spatial resolution.

Advantageously, it is optionally provided that the illumination device and the camera are oriented at the same angle to the pane so that the light pattern features reflected on the pane fall perpendicularly into the camera. This makes it particularly easy to evaluate the images recorded by the camera, as there is no need for time-consuming correction of distorted images caused by the light pattern features entering the camera at an angle.

Advantageously, several cameras arranged next to each other or oriented with adjacent light pattern feature sections are used to capture particularly wide light pattern features.

Due to the change in the angle of incidence of the light rays to the pane caused by the surface deformation contained in the pane, or the change in the angle of emission of the light rays reflected by the to the pane, the light rays strike the image sensor of the camera used at different positions. When using a line scan camera or when evaluating only individual image lines of a area scan camera, the surface deformation therefore causes different areas of the light pattern to be viewed, so that the dimensions of adjacent light pattern features differ from each other and individual dimensions also differ from reference dimensions. The surface deformation of the pane can be determined by evaluating the position of the reflected light pattern feature or the deviation of the dimensions of the light pattern features or the light pattern feature sections.

It is also envisaged that the light pattern feature is designed as an isosceles and acute-angled triangle. When using a light pattern feature in the form of a triangle with known side lengths and interior angles, a displacement or rotation of the pane can be determined at a distance specified between the sides of the triangle when cutting through the triangular light pattern feature.

In addition, a distortion of the light pattern feature in the transport direction and along the transverse axis can be evaluated separately. The distortion of the light pattern feature caused in the transport direction by the surface deformation of the pane can be evaluated in the form of a cyclic and wave-like change in the width of the triangular light pattern feature.

In an advantageous embodiment, the geometric parameter describes a distance between two intersection points, wherein the intersection points are generated by an intersection of an intersection line with two sides of the light pattern feature. Since the dimensions of the light pattern features can be determined in a reference measurement on a reference surface, a change in the distance can be used to determine the surface deformation of the pane. The intersection line corresponds to the strip-shaped recording region recorded by the camera.

In order to determine the geometric parameters described by the light pattern features with particular accuracy, an advantageous embodiment provides that the light pattern features are filled in. When using light pattern features spaced apart from one another, a particularly high-contrast and thus sharp transition between the light pattern feature projected onto the pane and an area adjacent to the light pattern feature can thus be recorded. This allows the local surface deformation to be determined particularly well.

By filling in, for example, triangular light pattern features, a particularly high contrast can be created between a bright area of the pane illuminated by the light pattern feature and an unilluminated area of the pane, or between adjacent light pattern features and dimly lit dark areas. This allows transitions between the light pattern feature and the unilluminated area to be determined with particular accuracy and reproducibility.

Advantageously, a light band may be projected onto the pane in front of and/or behind the light pattern in the transport direction. In this way, it can be automatically determined that the camera and the projector are oriented in such a way that the maximum measuring range has been left.

It may be provided that the light band is directly adjacent to the light pattern so that the light pattern features and the light band merge into one another.

Advantageously, dark areas between adjacent light pattern features of the light pattern may also illuminated by the illumination device, whereby the illumination intensity of the dark areas is lower than the illumination intensity of bright areas of the light pattern. In this way, even in the dark areas, it is still possible to differentiate between the glass surface and the area without glass, for example, in order to identify glass edges or the positions of drill holes.

To project the light pattern, the illumination device advantageously has a projection lamp and a light pattern element arranged in a projection region of the projection lamp. The light pattern element can be, for example, a film that has translucent and non-translucent or weakly translucent regions. The light pattern is generated by illuminating the film arranged between the projection lamp and the pane with the projection lamp in a manner that is. In order to also illuminate the dark areas weakly, the weakly translucent regions can have a low transparency.

Advantageously the illumination intensity of the dark areas is a maximum of 10%, advantageously a maximum of 5%, and particularly advantageously a maximum of 2% of the illumination intensity of the light areas.

In order to further increase the measurement accuracy when using several light pattern feature parts the illumination intensities of the light pattern feature parts of a light pattern feature differ from one another. In this way, even when using a line scan camera, for example, it is possible to determine which area of the light pattern is being viewed.

In order to be able to detect the flatness of the pane across its entire width, an advantageous implementation provides that a strip-shaped recording region of the pane is captured in an image recorded by the camera, wherein the strip-shaped recording region is oriented parallel to the transverse axis and the pane is completely captured along the transverse axis.

In order to be able to determine the flatness along the transverse axis of the pane with particular accuracy, an advantageous embodiment provides that the triangular light pattern features are oriented such that the tips of the light pattern features point in or against the transport direction. Furthermore, it may also be provided that the base of a light pattern feature designed as an isosceles triangle is oriented parallel to the transverse axis. Thus, the illumination generated by the illumination device can be oriented with the transverse axis and the camera's recording region can be oriented particularly easily along the base of the triangle projected onto the pane.

In order to be able to measure a particularly large number of triangular light pattern features, an advantageous embodiment provides that the light pattern features are oriented such that the tips of adjacent triangular light pattern features point alternately in and against the transport direction. The number of triangular light pattern features along the transverse axis determines the resolution of the measuring method along the transverse axis and thus across the width of the pane. This means that the number of data points for determining geometric parameters is particularly large, enabling local curvatures of the surface deformation to be determined in each strip-shaped recording region and thus per pixel line of the line camera.

In order to enable a particularly accurate determination of the geometric features, an advantageous embodiment of the method provides for adjacent light pattern features with different light intensities to be projected onto the pane. A particularly large contrast can be generated between two adjacent light pattern features. This means, for example, that the intersection points used to determine the geometric parameters can be determined with particular accuracy.

It is also possible and provided for that differently designed light patterns are projected onto the pane one after the other and captured by the camera, wherein the light pattern features of each light pattern projected onto the pane immediately adjacent to one another are designed and arranged in such a way that all feature distances determined perpendicular to the transport direction between facing outer contours of the light pattern features projected immediately adjacent to one another differ from one another. Light patterns with triangular light pattern features can be used, for example, wherein the triangles of the light patterns projected successively onto the pane each have base sides of different lengths, for example. Different surface deformations have different effects on the light pattern features used in each case. By using different light pattern features in successive projection steps, any surface deformations can be determined accurately, since a weaker effect of a surface deformation on a first light pattern can be compensated for by a stronger effect of the surface deformation on a second light pattern.

In practice, it is usually not possible, or only possible with great effort, to align the camera, the projection device, and the pane orthogonally to each other. It is therefore advisable to calibrate the measuring device before performing a measurement. Advantageously, when evaluating the images captured by the camera, an alignment of a recording region of the camera relative to the projected light pattern, determined in a calibration step preceding the capture of the images, is taken into account. Knowing the relative position of the light pattern on the pane relative to the camera, the evaluation steps described above can be performed very precisely.

The task set out at the beginning is also solved by a measuring device, wherein the measuring device comprises a transport device for moving the pane relative to the illumination device and the camera or for moving the illumination device and the camera relative to the pane in the transport direction, wherein the illumination device can project the light pattern consisting of several two-dimensional light pattern features onto the pane, wherein the camera is oriented such that the light pattern reflected by the pane can be detected at least partially by the camera, wherein a geometry parameter of the light pattern features recorded by the camera can be determined using the evaluation device, wherein the camera is designed as a line scan camera. The design of the camera as a line scan camera makes it particularly easy and quick to align the camera relative to the pane, since the strip-shaped recording region is oriented parallel to the transverse axis in a simple, easy-to-e manner in order to align the strip-shaped recording region on the pane. The illumination of the pane generated by the illumination device can also be easily adjusted to focus on the strip-shaped area.

Furthermore, the images captured by the line scan camera can be evaluated quickly and easily by evaluating the image information pixel line by pixel line. A pixel line of the camera can be evaluated at a higher clock rate than the evaluation of flat image information recorded by a area scan camera. This means that the geometric parameters can be determined particularly quickly by evaluating the images. The use of a line scan camera or the advantageous evaluation of only individual lines of the captured camera image from an area scan camera advantageously allows a high spatial resolution of the camera image in the transport direction.

In order to be able to implement a stationary measuring device particularly easily, an advantageous embodiment provides that the transport device is designed as a roller conveyor or belt conveyor, with which the pane is moved relative to the illumination device and the camera in the transport direction. Such roller conveyors and belt conveyors are known from manufacturing plants for glass panes, so that they can be used for positioning the pane in the transport direction. The illumination device and the camera can thus be attached particularly easily to stationary profile constructions that are easy to implement. A complex and potentially expensive drive device for the movement of the illumination device and the camera is not necessary. This makes it particularly easy to preset and adjust the distance between the illumination device and/or the camera relative to the transport device.

For particularly good accessibility to the illumination device and/or the camera, an advantageous implementation provides for the camera to be arranged on the side of the pane facing away from the roller conveyor or the belt conveyor. This allows the illumination device and the camera to be oriented at the same angle to the pane.

Advantageously, the lighting device comprises a projection lamp and a light pattern element arranged in front of the projection lamp in a projection region of the projection lamp, wherein the light pattern element has several translucent regions, through which the light pattern is formed. The light pattern element is arranged between the projection lamp and the pane. The light pattern element may, for example, be a film having translucent and non-translucent or weakly translucent regions through which the light pattern is formed.

Further advantageous embodiments are explained with reference to the embodiments shown in the drawings.

### BRIEF DESCRIPTION OF THE DRAWINGS

FIG. 1 a schematic representation of the measuring device in a side view,

FIG. 2 shows a schematic representation of the measuring device in a top view,

FIG. 3 a schematic representation of a light pattern projected onto the pane,

FIG. 4 shows a schematic representation of a section of the light pattern shown in FIG. 3,

FIG. 5 a schematic representation of individual images recorded and assembled by the line scan camera, and

FIG. 6 is a schematic representation of a light pattern with light pattern features that have several light pattern feature parts.

### DETAILED DESCRIPTION

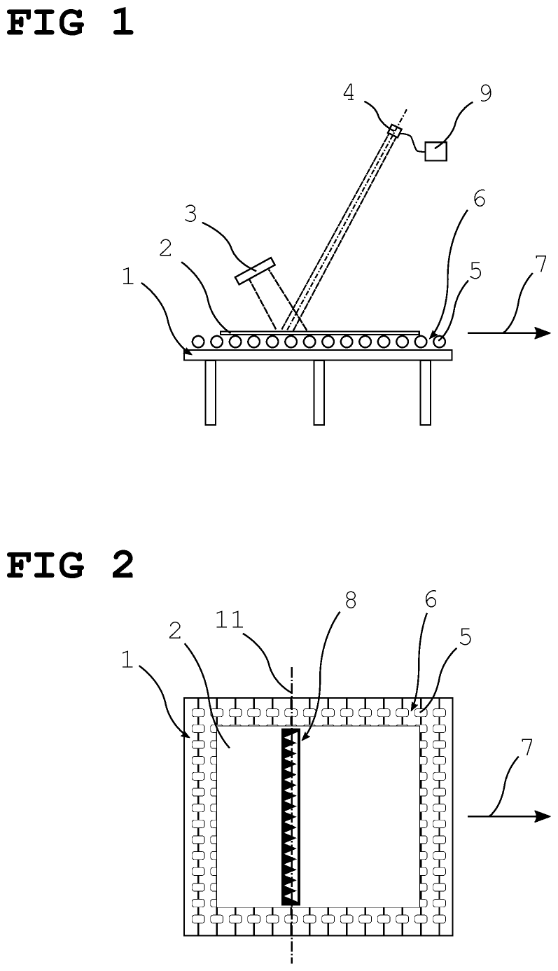

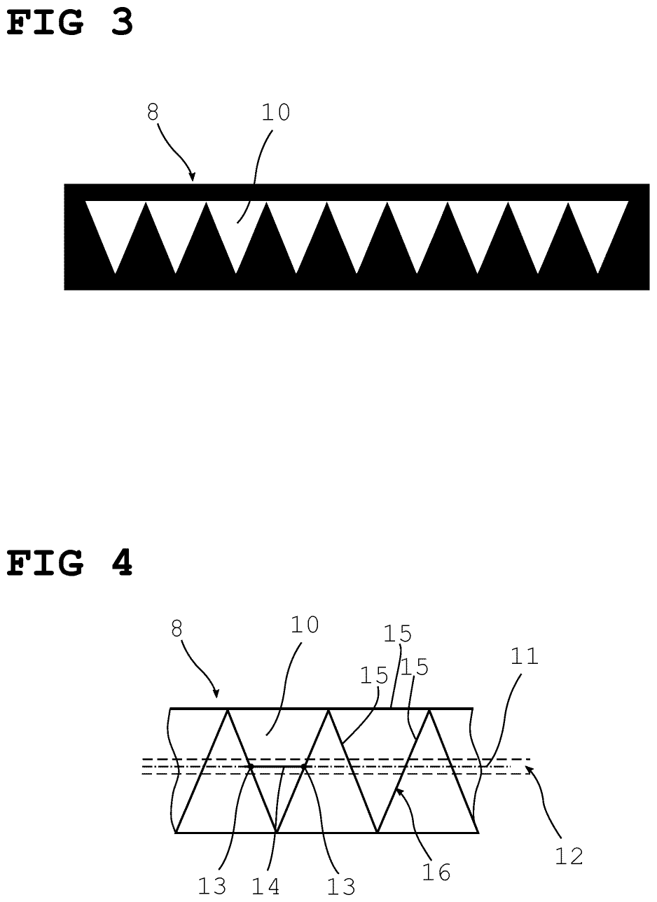

FIG. 1 shows a schematic representation of the measuring device in a side view. A transport device 1 is used to position a pane 2 relative to an illumination device 3 and a camera 4 designed as a line scan camera. The pane 2 lies flat and horizontally on a plurality of transport rollers 5 of the transport device 1, which is designed as a roller conveyor 6, and is positioned in a transport direction 7. The illumination device 3 projects a light pattern 9, shown in FIG. 3, onto the pane. The light pattern 8, which consists of a plurality of light pattern features 10 shown in FIG. 3, is projected onto the pane 2 along a transverse axis 11 oriented perpendicular to the transport direction 7, which is shown in FIG. 2. The light pattern 9 reflected by the pane is at least partially captured by the camera 4. The camera 4, which is designed as a line scan camera, records a strip-shaped recording region 12 oriented along the transverse axis. An evaluation device 9 determines the geometric parameters of the light pattern features 10 recorded by the camera 4 and shown in FIG. 3.

FIG. 3 shows a schematic representation of the light pattern 8 projected onto the pane 2. The light pattern 8 is formed from several triangular light pattern features 10 arranged next to each other. The light pattern features 10 are oriented such that the tips of adjacent triangular light pattern features 10 point in the transport direction 7 shown in FIG. 2.

FIG. 4 shows a schematic representation of a section of the light pattern 8 shown in FIG. 3. The side edges of the triangular light pattern features 10 each form a polygonal line section 15. Together, the polygonal line sections 15 form the polygonal line 16 enclosing the entire triangular light pattern 10. A distance between two intersection points 13, which are generated by an intersection of an intersection line 14 through two sides of the light pattern feature 10, is used as a geometry parameter. The intersection line 14 is determined by the strip-shaped recording region 12 of the camera 4.

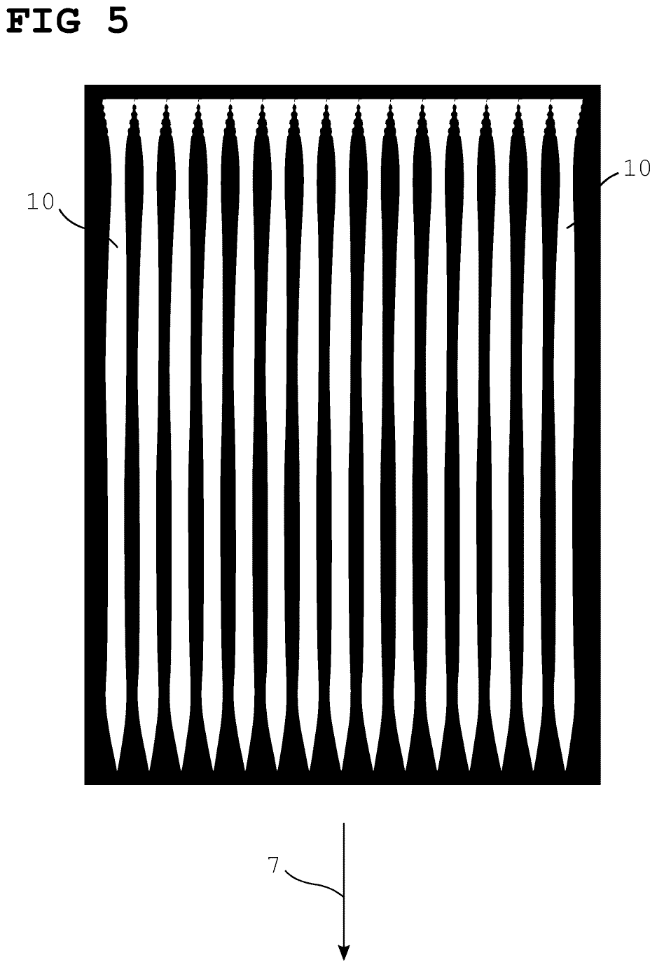

FIG. 5 shows a schematic representation of individual images recorded and assembled using the camera 4 shown in FIG. 1. The surface deformation of the pane 2 can be determined by the change in the width of the light pattern features 10 recorded by the camera 4 within the recording region 12. The distortion of the light pattern feature 10 caused by the surface deformation of the pane 2 in the transport direction 7 is recognizable in the form of a cyclic and long-wave-like change in the width of the triangular light pattern feature 10.

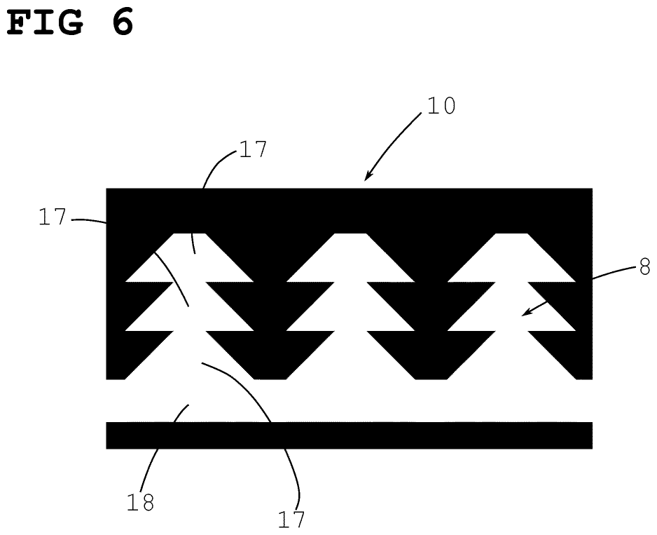

FIG. 6 shows a section of a light pattern 8. The light pattern features 10 of this light pattern 8 each consist of three trapezoidal light feature parts 17. With reference to the representation below the light pattern 8, light band 18 is projected onto the pane immediately adjacent to the light pattern 8.

In the illustrations in FIGS. 1 to 6, only individual elements of several similar elements are marked with a reference number for illustrative purposes.

### LIST OF REFERENCE CHARACTERS

1. transport device
2. pane
3. illumination device
4. camera
5. transport roller
6. roller conveyor
7. transport direction
8. light pattern
9. evaluation device
10. light pattern feature
11. transverse axis
12. recording region
13. intersection
14. intersection line
15. polygonal line section
16. polygonal line
17. light feature parts
18. light band

1-21. (canceled)

22. A measuring method for determining a flatness of a transparent pane (2), comprising:
displacing the transparent pane (2) relative to an illumination device (3) and a camera (4) by a transport device (1), or displacing the illumination device (3) and the camera (4) relative to the transparent pane (2) in a transport direction (7);
projecting, by the illumination device (3), a light pattern (8) comprising a plurality of light pattern features (10) onto the transparent pane (2),
wherein the plurality of light pattern features (10) are projected onto the transparent pane (2) next to one another in a transverse axis (11) oriented perpendicular to the transport direction (7);
detecting, by the camera (4), at least a portion of the light pattern (8) reflected by the transparent pane (2);
determining a geometric parameter of the light pattern features (10) detected by the camera (4); and
evaluating a plurality of images captured in succession by the camera (4) and determining a change in the geometric parameter of one or more of the light pattern features (10) caused by reflections on the transparent pane (2),
wherein a circumferential line of the light pattern features (10) is formed by a polygonal line (16) comprising a plurality of straight polygonal line sections (17), and
wherein polygonal line sections (17) of adjacent light pattern features (10) facing each other are not oriented parallel to one another.

23. The measuring method according to claim 22,
wherein light pattern features (10) projected directly next to each other onto the transparent pane are designed and arranged in such a way that all feature distances determined perpendicular to the transport direction (7) between facing outer contours of the light pattern features (10) projected directly next to each other differ from each other.

24. The measuring method according to claim 22,
wherein the light pattern features (10) are triangular light pattern features (10).

25. The measuring method according to claim 22,
wherein the light pattern features (10) are formed from a plurality of trapezoidal light pattern feature parts (17) arranged one behind another in the transport direction (7) and adjacent to one another.

26. The measuring method according to claim 22,
wherein the geometric parameter describes a distance between two intersection points (13) generated by an intersection of an intersection line (14) with two sides of a respective one of the light pattern features (10).

27. The measuring method according to claim 22,
wherein the light pattern features (10) are designed to be filled in.

28. The measuring method according to claim 22,
wherein a light band (18) is projected onto the transparent pane in the transport direction (7) in front of and/or behind the light pattern (8).

29. The measuring method according to claim 28,
wherein the light band (18) is directly adjacent to the light pattern (8) so that the light pattern features (10) and the light band (18) merge into one another.

30. The measuring method according to claim 22,
wherein dark areas between light pattern features (10) of the light pattern (8) arranged adjacent to one another are also illuminated by the illumination device (3),
wherein an illumination intensity of the dark areas is lower than the illumination intensity of bright areas of the light pattern (8).

31. The measuring method according to claim 30,
wherein the illumination intensity of the dark areas is at most 10% of an illumination intensity of the bright areas.

32. The measuring method according to claim 25,
wherein illumination intensities of the light pattern feature parts (17) of a light pattern feature (10) differ from one another.

33. The measuring method according to claim 22,
wherein a strip-shaped recording region (12) of the transparent pane (2) is captured in an image recorded by the camera (4),
wherein the strip-shaped recording region (12) is oriented parallel to the transverse axis (11) and the transparent pane (2) is completely captured along the transverse axis (11).

34. The measuring method according to claim 24,
wherein the triangular light pattern features (10) are oriented such that tips of the light pattern features (10) point in or against the transport direction.

35. The measuring method according to claim 24,
wherein the light pattern features (10) are oriented such that tips of adjacent triangular light pattern features (10) point alternately in or against the transport direction (7).

36. The measuring method according to claim 22,
wherein adjacent light pattern features (10) with different light intensities are projected onto the transparent pane (2).

37. The measuring method according to claim 22,
wherein differently designed light patterns (8) are projected onto the transparent pane (2) one after another and detected by the camera (4),
wherein the light pattern features (10) of each light pattern projected onto the transparent pane, which are projected directly next to each other onto the transparent pane, (8) are designed and arranged in such a way that all feature distances determined perpendicular to the transport direction (7) between facing outer contours of the light pattern features (10) projected directly next to each other differ from each other.

38. The measuring method according to claim 22,
wherein, when evaluating the images captured by the camera (4), an alignment of a recording region of the camera (4) with respect to the projected light pattern (8), determined in a calibration step preceding the capture of the images, is taken into account.

39. A measuring device for determining a flatness of a transparent pane (2), the measuring device comprising:
a transport device (1) for moving the transparent pane (2) relative to an illumination device (3) and a camera (4) or for moving the illumination device (3) and the camera (4) relative to the transparent pane (2) in a transport direction (7),
wherein the illumination device (3) is configured to project a light pattern (8) comprising a plurality of light pattern features (10) onto the transparent pane (2),
wherein the camera (4) is oriented such that the light pattern (8) reflected by the transparent pane (2) can be detected at least partially by the camera (4),
wherein a geometric parameter of the light pattern features (10) recorded by the camera (4) can be determined using an evaluation device (9), and
wherein the camera (4) is designed as a line scan camera.

40. The measuring device according to claim 39,
wherein the transport device (1) is designed as a roller conveyor or a belt conveyor, with which the transparent pane (2) is moved relative to the illumination device (3) and the camera (4) in the transport direction (7).

41. The measuring device according to claim 40,
wherein the camera (4) is arranged on a side of the transparent pane (2) facing away from the roller conveyor or the belt conveyor.

42. The measuring device according to claim 39,
wherein the illumination device (3) comprises a projection lamp and a light pattern element arranged in front of the projection lamp in a projection region of the projection lamp, wherein the light pattern element comprises a plurality of translucent regions, wherein the light pattern (8) is formed by the translucent regions.
